(19) United States
(12) Patent Application Publication
(10) Pub. No.: US 2009/0304091 A1
(43) Pub. Date: Dec. 10, 2009

(54) Method and Apparatus for Decoding/Encoding of a Scalable Video Signal

(76) Inventors: Seung Wook Park, Seoul (KR); Byeong Moon Jeon, Seoul (KR); Ji Ho Park, Seoul (KR)

Correspondence Address: HARNESS, DICKEY & PIERCE, P.L.C., P.O. BOX 8910, RESTON, VA, 20195, US

(21) Appl. No.: 12/225,863

(22) PCT Filed: Apr. 3, 2007
(86) PCT No.: PCT/KR2007/001630

§ 371 Date: Mar. 30, 2009

Related U.S. Application Data
(60) Provisional application No. 60/788,091, filed on Apr. 3, 2006.
(60) Provisional application No. 60/789,573, filed on Apr. 6, 2006.

(51) Int. Cl. H04N 7/26

(52) U.S. Cl. 375/240.26; 375/240.01; 375/E07.078

(57) ABSTRACT

In decoding for a data layer for received SNR enhancement, provided is a decoding method including the steps of extracting number information for selector information related to a set of base values in coding data of a plurality of blocks in an arbitrary picture belonging to the received data layer from the received data layer, obtaining 1-dimensional selector information by extracting the base values from the received data layer, as indicated, by the extracted number information from the received data layer, and decoding data within the received data layer into data of each of the blocks prior to coding based on the 1-dimensional selector information.

### TECHNICAL FIELD

The present invention relates to decoding/encoding of a scalable video signal.

### BACKGROUND ART

Generally, a scalably encoded bit stream can be selectively decoded in part. For instance, a decoder having a low complexity is capable of decoding a base layer and a bit stream of a low bit rate can be extracted for a transmission via a network having a limited capacity. In order to generate an image of gradually increasing resolution, it is necessary to increase an image quality of video step by step.

### DISCLOSURE OF THE INVENTION

### Technical Object

The object of the present invention is to enhance coding efficiency of a video signal.

### Technical Solution

An object of the present invention is to enhance coding efficiency of a video signal by reducing a quantity of data becoming a reference for data coding.

Another object of the present invention is to secure flexibility in providing data becoming a reference for data coding.

Another object of the present invention is to provide a method and apparatus for using data becoming a reference for data coding for data decoding, by which a data size is reduced or by which flexibility is secured.

### ADVANTAGEOUS EFFECTS

Accordingly, coding efficiency is enhanced by reducing overhead of data transmitted within a range that does not affect an image quality. And, coding efficiency of a video signal can be enhanced by securing VLC selector's flexibility maximally.

### BRIEF DESCRIPTION OF THE DRAWINGS

FIG. 1 is a schematic diagram of a video signal encoder placed an emphasis on coding of FGS (fine grained scalability) data according to an embodiment of the present invention.

FIG. 2 is a schematic diagram of a process for coding a picture having FGS data according to an embodiment of the present invention.

FIG. 3 is a diagram of a VLC selector array used in coding significance data of FGS data according to an embodiment of the present invention.

FIG. 4 is an example of a codebook used in coding significance data according to an embodiment of the present invention.

FIG. 5 is a schematic diagram of a video signal encoder placed an emphasis on coding of FGS data according to another embodiment of the present invention.

FIG. 6 is an example of a structure of VLC selector information according to an embodiment of the present invention.

FIG. 7 is an example of syntax for coding/decoding information related to VLC selection according to an embodiment of the present invention.

FIG. 8 is an example of a process for coding significance data according to an embodiment of the present invention.

FIG. 9 and FIG. 10 are examples of information indicating a type of VLC selector information according to another embodiment of the present invention, respectively.

FIG. 11 is a schematic diagram of a configuration of an apparatus for decoding an FGS coded data stream.

### BEST MODE FOR CARRYING OUT THE INVENTION

To achieve these and other advantages and in accordance with the purpose of the present invention, as embodied and broadly described, in decoding for a data layer for received SNR enhancement, a decoding method according to the present invention includes the steps of extracting number information for selector information related to a set of base values in coding data of a plurality of blocks in an arbitrary picture belonging to the received data layer from the received data layer, obtaining 1-dimensional selector information by extracting the base values from the received data layer, as indicated, by the extracted number information, and decoding data within the received data layer into data of each of the blocks prior to coding based on the 1-dimensional selector information.

To further achieve these and other advantages and in accordance with the purpose of the present invention, in decoding a scalable video signal, a decoding method includes the steps of extracting size information for selector information related to a set of base values in coding data of a plurality of blocks in an arbitrary picture belonging to the received data layer from the received data layer, obtaining the selector information by extracting the base values from the received data layer, as indicated by the extracted size information from the received data layer, and decoding data within the received data layer into data of each of the blocks prior to coding based on the selector information, wherein the selector information has a matrix configuration of at least 1 dimension.

To further achieve these and other advantages and in accordance with the purpose of the present invention, in encoding a data layer for SNR enhancement, an encoding method includes the steps of determining a number for 1-dimensional selector information related to a set of base values for coding data of each block within an arbitrary picture of the layer, configuring the 1-dimensional selector information having the determined number, and after the data within the each block has been coded, including the configured 1-dimensional selector information and information for the determined number in a stream to be transferred together with the coded data.

To further achieve these and other advantages and in accordance with the purpose of the present invention, in decoding for a data layer for received SNR enhancement, a decoding apparatus includes a processor extracting number information for selector information related to a set of base values in coding data of a plurality of blocks in an arbitrary picture belonging to the received data layer from the received data layer, the processor configuring 1-dimensional selector information by extracting the base values from the received data layer, as indicated, by the extracted number information, and a decoder decoding data within the received data layer into data of each of the blocks prior to coding based on the configured 1-dimensional selector information.

According to one embodiment of the present invention, the selector information can be 1-dimensionally configured. In an embodiment of configuring the selector information 1-dimensionally, a base for selecting one element used for data coding in the configured selector information may be a sequence on a scan path at a current scan position in a coding process of data within a block.

According to another embodiment of the present invention, the selector information can be configured with at least two dimensions.

According to one embodiment of the present invention, a size of the selector information is variable for use.

According to another embodiment of the present invention, a fixed size is usable for the selector information.

### MODE FOR INVENTION

Reference will now be made in detail to the preferred embodiments of the present invention, examples of which are illustrated in the accompanying drawings.

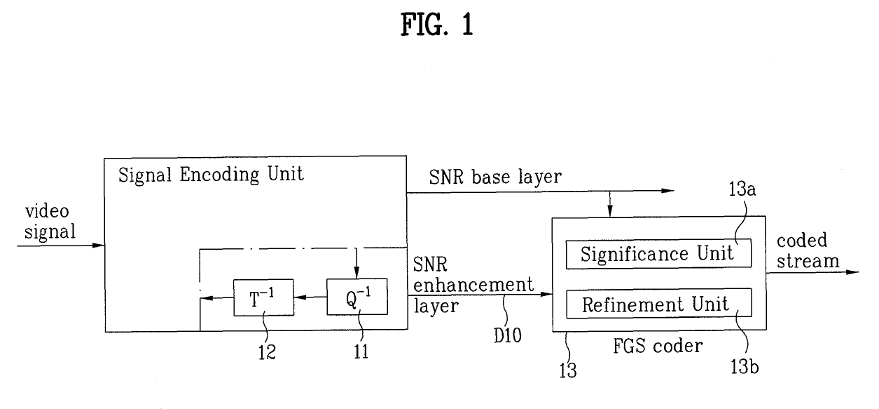

FIG. 1 is a schematic diagram of a video signal encoder placed an emphasis on coding of FGS (fine grained scalability) data according to an embodiment of the present invention.

An encoder encoding a video signal by a scalable scheme performs transformation coding, e.g., DCT and quantization on data encoded by motion estimation and prediction operation for each frame of a received video signal. And; loss of information is generated in the course of the quantization. So, the encoder, as shown in FIG. 1, obtains a difference between the encoded data and the inverse-transformed data after performing de-quantization 11 and inverse transformation 12 and then generates SNR enhancement layer data D10 on a DCT domain by performing DCT and quantization on the difference. In this case, the difference between the encoded data and the inverse-transformed data may mean the data compensating for error occurring in performing the encoding. Thus, by providing data of SNR enhancement layer for SNR enhancement, an image quality can be gradually enhanced as a decoding level of the data of the SNR enhancement layer is raised. This is called FGS (fine grained scalability). And, coding is carried out on the SNR enhancement layer data to convert to a data stream by an FGS coder 13 shown in FIG. 1. In doing so, coding is carried out according to a significance data path (hereinafter abbreviated ‘significance path’) and a refinement data path (hereinafter abbreviated ‘refinement path’). In the significance path, data of SNR enhancement layer, in which co-located data on an SNR base layer has a value of 0, is coded. In the refinement path, data of SNR enhancement layer, in which co-located data on an SNR base layer does not have a value of 0, is coded.

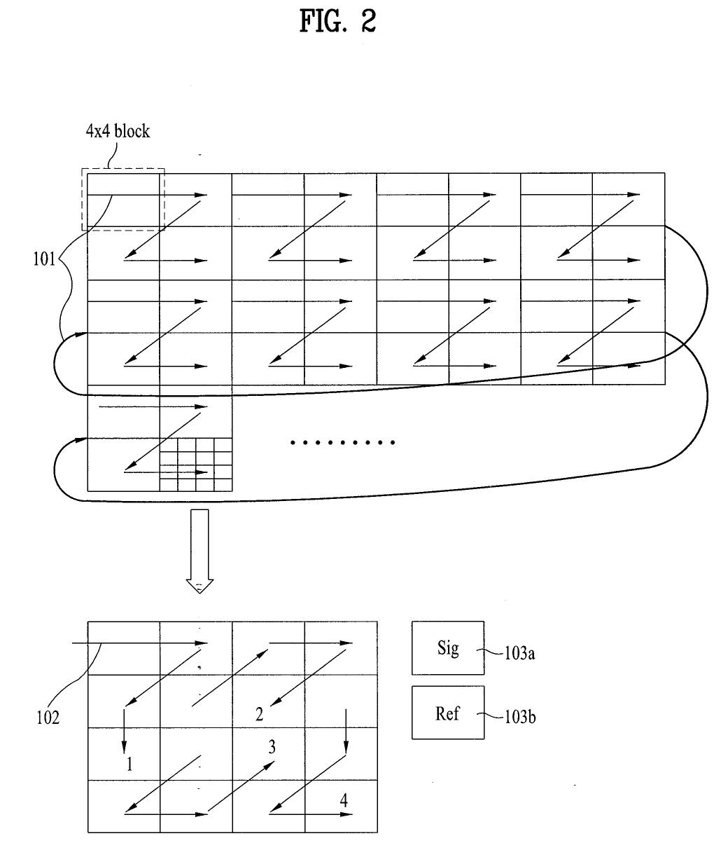

FIG. 2 is a schematic diagram of a process for coding a picture having FGS data according to an embodiment of the present invention. In FIG. 2, it shows an example of a process for coding data in a significance path coding unit 13a on the significance path according to an embodiment of the present invention.

The present embodiment is applicable to SNR enhancement layer data belonging to one picture each cycle. Data are read along a determined zigzag scanning path 102 until significance data 103a, which is not zero, is met at a corresponding block while each block of 4×4 is selected according to a selection sequence 101 shown in FIG. 2. If so, a data stream, in which the read data excluding refinement data 103b are arranged, can be obtained. For the data stream, a run count of 0 can be coded by a specific scheme, e.g., S3 code. For the non-zero data, it can be coded by a separate scheme later. To achieve the coding using S3 code, the significance path coding unit 13a can be provided with VLC (variable length coding) selector array, which has a size 16×16 for the 4×4 block shown in FIG. 2 or a size 64×64 for 8×8 block, per a slice or layer.

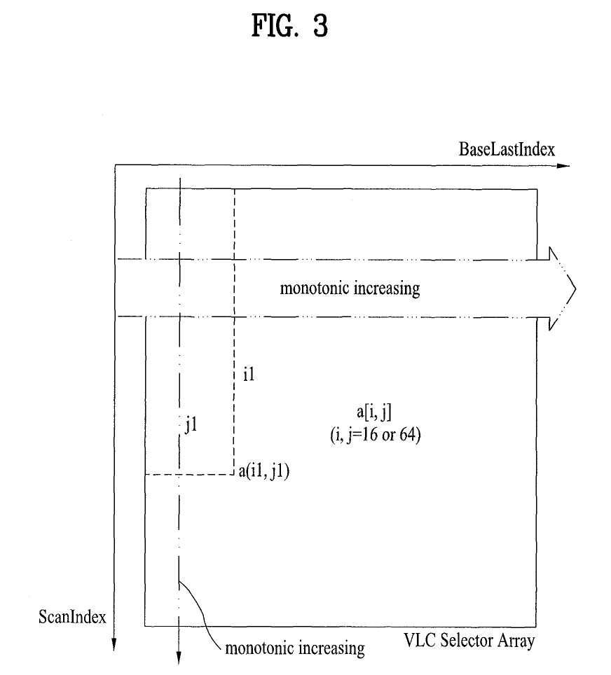

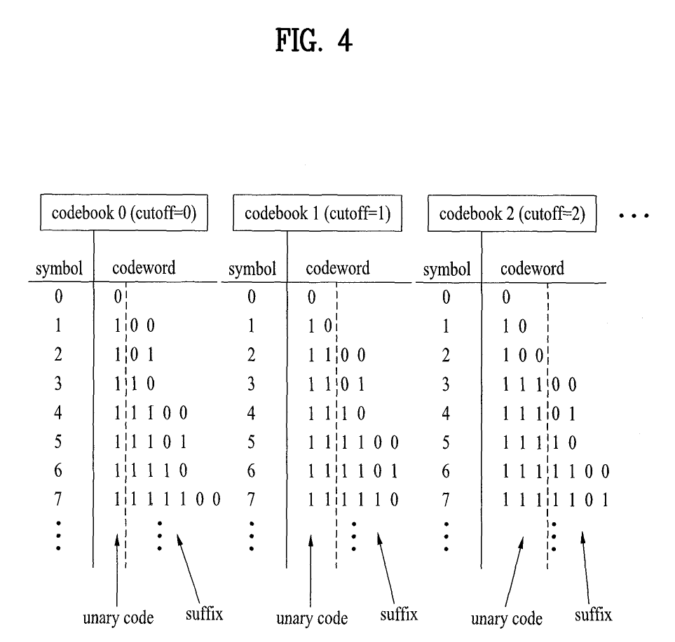

FIG. 3 is a diagram of a VLC selector array used in coding significance data of FGS data according to an embodiment of the present invention. In FIG. 3, it shows an example of 16×16 VLC selector array. In the array, the values, each of which indicates one of codebooks previously known to a decoder, can be recorded. Each of the codebooks, as shown in FIG. 4, includes a codeword group in which a truncated unary code and a suffix are combined according to a cutoff value.

Each element a[i,j] within the 2-dimensional VLC selector array shown in FIG. 3 can be selected by a scan start point (i=ScanIndex) on a start block in each cycle and a position (j=BaseLastIndex) of last non-zero data in a correspondent block on a lower layer (base layer or SNR base layer) to which a current block belongs. So, in scanning a random block, the significance path coding unit 13a obtains a scanning position i1 starting at a current cycle and a position j1 of a last non-zero data in a correspondent data of a lower layer. And, a codeword corresponding to the run count of zero to the next non-zero data on the scanning path is read from a codebook designated by a value of a[i1,j1] in the VLC selector array (or, rendered according to a codeword composing method) and coded data is then outputted.

The VLC selector array provided to the significance path coding unit 13a for data coding should be delivered to a decoder, whereby the aforesaid coded data can be reconstructed into the data prior to the coding. Yet, in case that the VLC selector array is made variable per slice, the VLC selector array has to be delivered to the decoder for each slice. So, overhead for video data is considerable. To reduce the overhead generated by the VLC selector array, each element within the array shown in FIG. 3 can be determined in a manner that a monotonic increasing value is set for a first column and each row. This is to reduce an actually transferred quantity by performing run length coding on values of the elements.

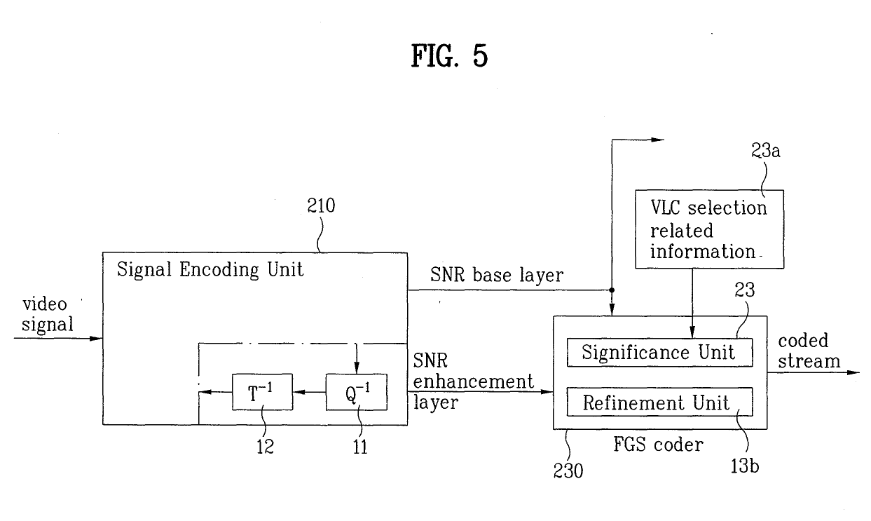

FIG. 5 shows a configuration of an encoding apparatus for performing a coding scheme according to the present invention. The encoder 210 generates SNR base layer data and SNR enhancement layer data (FGS data) by encoding an inputted signal. And, the generation of the FGS data can be carried out in the following manner.

The encoder 210 is preferentially able to find a difference between the encoded data and the inverse-transformed data by performing de-quantization 11 and inverse transform 12 on encoded SNR base layer data. In this case, the inverse-transformed data can be extended for execution if necessary. FGS data on DCT domain is generated by performing DCT and quantization on the found data sequentially and then applied to an FGS coder 230.

A significance path coding unit 23 within the FGS coder 230 is able to manage information 23a related to VLC selection to perform FGS coding scheme using VLC selector information that is explained in the following description. The information 23a can include VLC selector information, i.e., cutoff values and/or type information for VLC selector, etc. And, coding scheme suitable for stream transmission is performed on the encoded SNR base data n the apparatus shown in FIG. 5.

The significance path coding unit 23 in FIG. 5 performs coding on data according to the scheme of each embodiment explained in the following description by selecting 4×4 block for one picture (frame, slice, etc.) by the method explained in FIG. 2 and configures information related to VLC selection as well. Of course, the scheme explained in the following description is applicable to each block even if a block selecting sequence is used in a manner different from the scheme explained in FIG. 2 is used. So, the present invention is not restricted by the block selecting sequence. And, the schemes of the respective embodiments explained in the following description are applicable to the case that picture data is a chrominance component as well as a luminance component.

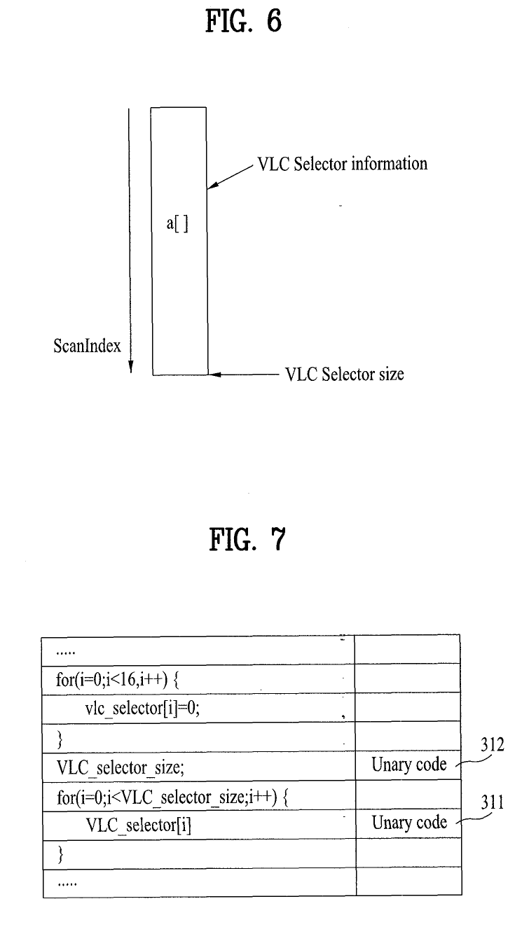

First of all, according to one embodiment of the present invention, as shown in FIG. 6, the VLC selector information may be configured by one dimension and a variable VLC_selector_size indicating the number of the VLC selector information a[ ] can be used as type information for the VLC selector. And, an indication value (e.g., a cutoff value of S3 code) indicating one of previously provided codebooks, which is suitable for a start position (ScanIndex) for scanning in a current cycle of a currently coded block, can be recorded in each element a[I] of the VLC selector information. Since a quantity of the VLC selector information is reduced according to the present invention, it is unnecessary to configure each of the elements a[I] of the VLC selector information with a monotonic increasing value to enhance a coding efficiency. For instance, it is unnecessary to set a[j] equal to or greater than a[i] (j>i). Coding scheme for data in a random block will be explained later. The significance path coding unit 23 is able to decide and record a value of each element of the VLC selector information. Yet, the VLC selector information having a suitable element value is previously determined by the following method and then provided to the significance path coding unit 23.

The size variable VLC_selector_size is not fixed to 16 and can have a value smaller than 16. This may happen, when the information related to VLC selection is transferred each slice, in case that a last scan start position of all blocks belonging to a specific slice is smaller than 15.

The significance path coding unit 23 is able to code the VLC selector information and a size variable of the information according to the syntax exemplarily shown in FIG. 7. For instance, since sixteen scan start positions can basically exist for 4×4 block, it is able to initialize VLC selector information VLC_selector[ ] having sixteen elements. And, it is able to insert an indication value (e.g., coded into a truncated unary code) to be used or have been used in coding a run count of 0 read by a scan of each block in each element of the VLC selector information for a current slice (311). And, a value for specifying a size of the VLC selector information can be coded into a unary code as well (312). A size value of the VLC selector information can be coded to have a fixed length. The above-coded information related to VLC selection (VLC selector information and its size information) is inserted in a header of a slice (case that VLC selector information varies for each slice) or a header of a layer

syntax level or above and is then transferred to a decoder terminal.

The examples shown in FIG. 6 and FIG. 7 are applicable to 8×8 block as well as 4×4 block. In this case, a range of the VLC selector information VLC_selector[ ] to be initialized is between 0˜63. In case of the 8×8 block, it is able to set a size of the VLC selector information for the block to 16 like the case of 4×4 block in a manner of having the VLC selector information shared according to a data position.

According to another embodiment of the present invention, by configuring VLC selector information in a 1 dimensional format of a fixed length having sixteen elements, it is able not to provide a size variable of the VLC selector information to a decoder.

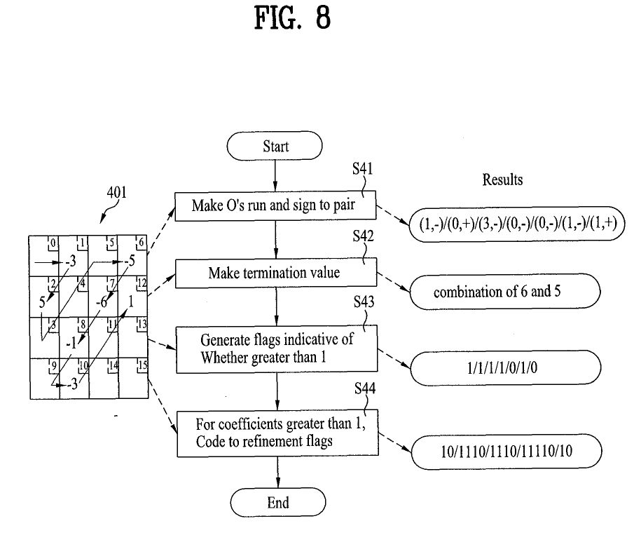

For data in a random block, i.e., quantized coefficients on a DCT domain, the significance path coding unit 23 is able to perform coding according to a process exemplarily shown in FIG. 8. For convenience of explanation, it is assumed that a block corresponding to a block 401, which is exemplarily shown in FIG. 8, on SNR base layer does not have non-zero data. This means that refinement data does not exist in the block 401. And, a non-zero coefficient (i.e., coefficient at a colored location) becomes significance data.

The significance path coding unit 23 is able to store a pair (Run, Sign) of signs of a run count of 0 and a non-zero coefficient by performing a scan to a non-zero coefficient along a specified zigzag scan path subsequent to a position at which a previous scanning stops for each cycle (S41). For the run count of 0 in the stored pairs, coding can be performed according to one of known methods. In this case, coding for the run count of 0 is performed by referring to a codebook specified according to a value of a corresponding element (element specified by a start scanning position) of the formerly configured VLC selector information VLC_selector[ ].

Once the above pairs are obtained for a current block, a termination value is made to be applied to a terminal end of a set of the pairs (S42). The termination value can result from combining two values. For instance, the termination value can be made using a greatest absolute value (‘6’ in the example of FIG. 8) among non-zero coefficients in a current block and a number of coefficients each of which absolute value is greater than 1 (‘5’ in the example of FIG. 8).

Subsequently, the significance path coding unit 23 is able to set flags for the pairs (seven pairs in the example of FIG. 8) obtained in the step S41, respectively (S43). In this case, each of the flags can be a value that indicates whether an absolute value of a non-zero coefficient corresponding to each of the pairs is greater than 1. For instance, if the absolute value is greater than 1, the corresponding flag can be set to 1. Otherwise, it can be set to 0. And, it is able to decide refinement flag information for coefficients of which the flag is set to 1 (S44). The refinement flag information can correspond to a value resulting from performing a unary coding on a value obtained from subtracting 2 from the absolute value of each of the coefficients. For instance, coding is performed in a manner of setting it to ‘0’ if an absolute value of a coefficient is 2, to ‘10’ if an absolute value of a coefficient is 3, ‘110’ if an absolute value of a coefficient is 4, or ‘1110’ if an absolute value of a coefficient is 5.

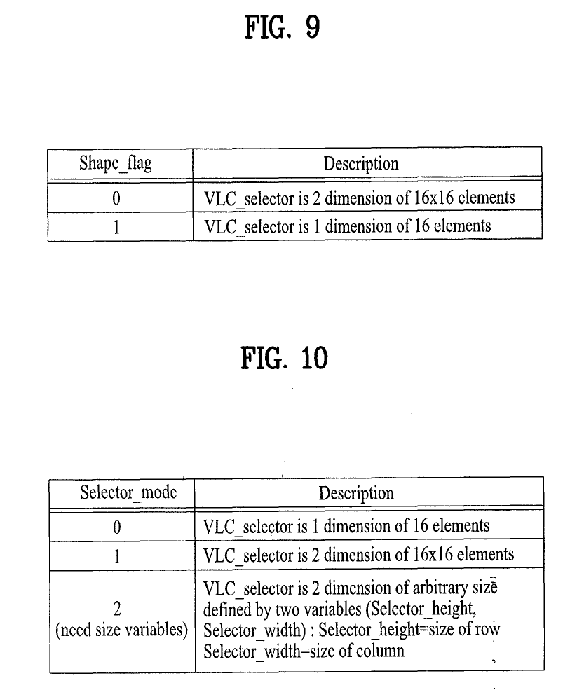

Another embodiment of the present invention is explained in the following description. In the present embodiment, flexibility enabling the VLC selector information to be configured in one dimension or at least two dimensions. For this, a shape flag Shape_flag is set for type information for the VLC selector and then provided to a decoder terminal. The shape flag information, as shown in FIG. 9, can be set to 1 for example if the VLC selector information is 1-dimensional for a size of 16 (for 4×4 or 8×8 block) or 64 (for 8×8 block). In case that the VLC selector information is 2-dimensional for 16×16 or 64×64 size, it can be set to 0. In case that the VLC selector information is 3-dimensional at least, it can be set to an appropriate value.

So, in the present embodiment, if it is advantageous to use 2-dimensional VLC selector information, a shape flag Shape_flag set to 0 can be transmitted together with the VLC selector information. Otherwise, a shape flag Shape_flag set to 1 can be transmitted together with 1 dimensional VLC selector information. Of course, in case of the transmission by one dimension, it is able to reduce a quantity of the information related to VLC selection.

In case of using 2-dimensional VLC selector information, a value of each element is determined by depending on a position (BaseLastIndex) where a last non-zero coefficient in a block of a lower layer corresponding to a current block exists as well as the aforesaid scan start position. And, a run count of the scanned 0 can be coded based on the determined value.

Yet, even if 2-dimensional VLC selector information is used, a position of a last non-zero coefficient in the entire blocks belonging to a slice of a lower layer corresponding to a current slice can exist at a specific position. For instance, in case of 4×4 block, the position of the last non-zero coefficient can exist ahead of a position of an index 14. In this case, a size of the 2-dimensional selector information can be set to 16×16 and then be transferred, but this may reduce coding efficiency.

Hence, in another embodiment of the present invention, number of the 2-dimensional VLC selector information can be set variable. In this case, information indicating the variable number can be transferred to a decoder as type information for the VLC selector.

In the present embodiment, the type information for the VLC selector can include selector's mode information (Selector_mode), and can include a size variable (Selector_width, Selector_height) according to a value of mode information.

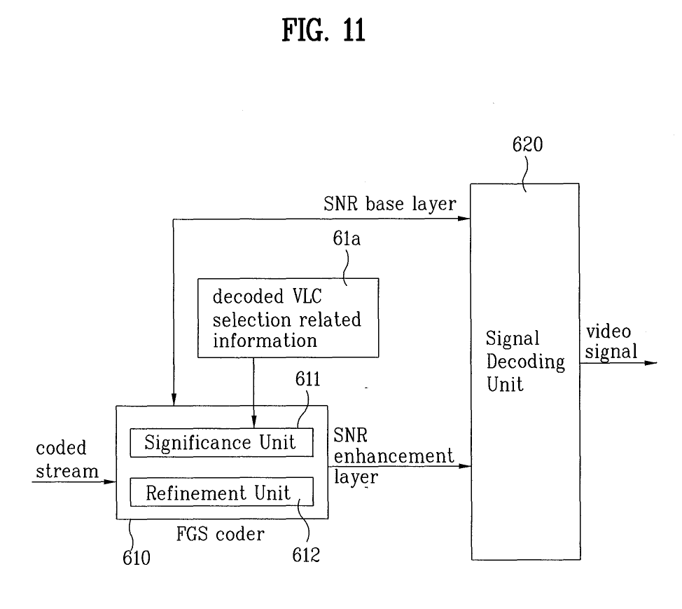

In the present embodiment, mode information for a VLC selector, as shown in FIG. 10, is set to 0 if VLC selector information is 1 dimension of 16 elements, for example. If VLC selector information is 2 dimensions of 16×16 elements, mode information for VLC selector is set to 1 for example. If a size of VLC selector information is variable, mode information for VLC selector is set to 2. And, its size information is set to row & column size variables Selector_height and Selector_width and then provided to a decoder.

The example shown in FIG. 10 relates to an example for 4×4 block. And, it is intactly applicable to the case of 8×8 block on the assumption that a value set for a size of VLC selector information, i.e., 16 is replaced by 64.

In case that 1-dimensional VLC selector information is designated, a cutoff value, which indicates one of previously provided codebooks suitable for a start position (ScanIndex) for the scan in a current cycle of a currently coded block, can be recorded in each element {VLC_selector[i] in case of being specified as 1 dimension, VLC_selector[i,j] in case of being specified as 2 dimension} of VLC selector information. In case that 2-dimensional VLC selector information is specified, it is able to record a cutoff value that indicates one of previously provided codebooks suitable for a start position (ScanIndex) for scan in a current cycle of a currently coded block and a position of a last non-zero coefficient on a block corresponding to a current block in a lower layer. And, the coding scheme for data in a random block has been explained in the above description.

The information related to VLC selection (VLC selector information and shape flag/mode information, etc.) proposed by the aforesaid embodiment, as mentioned in the foregoing description, can be transferred to the decoder by being inserted in a header of a slice (if VLC selector information varies for each slice) or a header of a layer syntax level or higher.

A decoding method of a decoder, which receives a data stream coded in the above manner, is explained as follows.

FIG. 11 is a block diagram of an apparatus for decoding a data stream coded by the apparatus shown in FIG. 5 according to one embodiment of the present invention. The data stream received by the apparatus shown in FIG. 11 is the data of which compression is decompressed by a proper decoding process. Once a stream of FGS data coded by the aforesaid scheme is received, a significance path decoding unit 611 within an FGS decoder 610 is able to configure each picture by decoding a significance data stream. In this case, VLC selection related information received by being inserted in a slice header, a layer header, or the like is decoded from the received stream and then stored in an internal memory of the significance path decoding unit 611 or a temporary memory (61a). The decoding for the header can be performed by another processor instead of the significance path decoding unit 611 and the corresponding result is then provided to the significance path decoding unit 611. Meanwhile, a refinement path decoding unit 612 decodes a refinement data stream and then supplements data to each picture to complete a perfect picture. Yet, the refinement data decoding unit 12 has less relation to the present invention and its details are omitted in the following description.

In decoding the information related to VLC selection, in case of the embodiment shown in FIG. 6, the significance path decoding unit 611 or a separate processor (not shown in the drawing) resets a space to be filed with the VLC selector information, e.g., a space corresponding to 16 elements, extracts a value for size variable (VLC_selector_size) of the VLC selector information, decodes values amounting to the extracted value, and then fills the reset space with the decoded values. So, the VLC selector information (VLC_selector[ ]) is configured.

Likewise, in case of the embodiment shown in FIG. 9 or FIG. 10, 1- or 2-dimensional VLC selector information can be obtained by decoding information for a VLC selector type (Shape_flag or Selector_mode) and then decoding 16, 16×16 or n×m values specified by a separately extracted size variable based on the decoded information.

Thus, once the VLC selector information is obtained (as mentioned in the foregoing description, the element values of the configured VLC selector information may not meet the constraint of ‘monotonic increasing’), the significance path decoding unit 611 specifies one element of the configured VLC selector information based on a scan start position of a block to be decoded, i.e., to be filled with data [in case of a configuration of 2-dimensional VLC selector information, additionally based on a position of a last non-zero coefficient on a correspondent block (decoding of this block is completed in advance) of a lower layer for a block to be currently decoded] and then reads a value of the specified element, i.e., an indication value indicating what VLC is used. Subsequently, the significance path decoding unit 611 searches a previously provided codebook specified by the read indication value for a bit sequence from a position on a stream to be currently decoded and then checks a symbol of the bit sequence. In this case, the checked symbol is able to indicate a position on a scan path of a non-zero coefficient on the block. So, it is able to pad zeros along the scan path up to the position. And, an actual value of the coefficient corresponding to the position can be determined from the flag (by S43) or the refinement flag (by S44) coded by FIG. 8 and then recorded in the corresponding position.

In this manner, values for significance data of all blocks for an arbitrary slice can be decoded. If a value at a correspondent position of an SNR base layer is not 0 (i.e., a position to be filed on the corresponding block corresponds to refinement data), the refinement path decoding unit 612 can fill the position with data.

In case that VLC selector information is specified for each slice, if decoding for one slice is completed, the previously configured VLC selector information is usable by being updated by the decoded information related to VLC selection.

The FGS data stream (significance data and refinement data) is fully reconstructed into slices on the DCT domain by the above explained process and then transferred to the decoder 620. The decoder 620 is able to reconstruct video data of a current macroblock by performing de-quantization and inverse transform (IDCT) to decode each SNR enhancement frame and then adding data of a formerly decoded reference block indicated by a motion vector to residual data of the current macroblock.

### INDUSTRIAL APPLICABILITY

Accordingly, the decoding apparatus can be loaded in a mobile communication terminal, a recording medium player, and the like.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. In decoding for a data layer for received SNR enhancement, a decoding method comprising the steps of:
extracting number information for selector information related to a set of base values in coding data of a plurality of blocks in an arbitrary picture belonging to the received data layer from the received data layer;
obtaining 1-dimensional selector information by extracting the base values from the received data layer, as indicated by the extracted number information; and
decoding data within the received data layer into data of each of the blocks prior to coding based on the 1-dimensional selector information.

2. The decoding method of claim 1, the decoding step comprising the steps of:
decoding a coding value indicating a run count of 0 into a value prior to the coding based on the 1-dimensional selector information for each of the blocks; and
determining a position of non-zero data for the corresponding block with the decoded value.

3. The decoding method of claim 2, wherein in a base layer of the data layer, a value of a position corresponding to the position of the non-zero data is 0.

4. The decoding method of claim 1, wherein in the decoding step, a base for selecting one element from the 1-dimensional selector information is a sequence on a specified scan path of a current scan position in the course of decoding each of the blocks.

5. The decoding method of claim 4, wherein one selector information exists at each scan position on the specified scan path.

6. The decoding method of claim 1, further comprising the step of initializing a value of each element of the 1-dimensional selector information.

7. The decoding method of claim 1, wherein the 1-dimensional selector information is recorded as an arbitrary element value without any constraint.

8. In decoding a scalable video signal, a decoding method comprising the steps of:
extracting size information for selector information related to a set of base values in coding data of a plurality of blocks in an arbitrary picture belonging to the received data layer from the received data layer;
obtaining the selector information by extracting the base values from the received data layer, as indicated by the extracted size information; and
decoding data within the received data layer into data of each of the blocks prior to coding based on the selector information,
wherein the selector information has a matrix configuration of at least 1 dimension.

9. In encoding a data layer for SNR enhancement, an encoding method comprising the steps of:
determining a number for 1-dimensional selector information related to a set of base values for coding data of each block within an arbitrary picture of the layer;
configuring the 1-dimensional selector information having the determined number; and
after the data within the each block has been coded, including the configured 1-dimensional selector information and information for the determined number in a stream to be transferred together with the coded data.

10. In decoding for a data layer for received SNR enhancement, a decoding apparatus comprising:
a processor extracting number information for selector information related to a set of base values in coding data of a plurality of blocks in an arbitrary picture belonging to the received data layer from the received data layer, the processor configuring 1-dimensional selector information by extracting the base values from the received data layer, as indicated by the extracted number information; and
a decoder decoding data within the received data layer into data of each of the blocks prior to coding based on the configured 1-dimensional selector information.
